(19) United States
(12) Patent Application Publication
(10) Pub. No.: US 2008/0230010 A1
(43) Pub. Date: Sep. 25, 2008

(54) AQUATIC PLANT DISPLAY SYSTEM

(76) Inventor: Randall Buck, Murrietta, CA (US)

Correspondence Address: ADVANTAGE IP LAW FIRM, 3020 OLD RANCH PARKWAY, SUITE 340, SEAL BEACH, CA, 90740, US

(21) Appl. No.: 12/035,227

(22) Filed: Feb. 21, 2008

Related U.S. Application Data
(60) Provisional application No. 60/891,032, filed on Feb. 21, 2007.

(51) Int. Cl. A01K 63/00

(52) U.S. Cl. 119/256; 52/27

(57) ABSTRACT

An aquatic plant display system for use in an aquarium or water filled environment and including a rack or frame body with one or more aquatic plant retainers having flexible variable width gripping elements wherein aquatic plants may be selectively and releasably captured by the display rack with the gripping elements inhibiting the aquatic plants from floating away from the display rack when placed underwater.

This application claims the benefit of co-pending provisional application U.S. Ser. No. 60/891,032, filed on Feb. 21, 2007, entitled Aquatic Plant Display Rack, which is hereby incorporated by reference in its entirety.

### BACKGROUND OF THE INVENTION

1. Field of the Invention

The present invention relates to plant display systems and, more specifically, to holders and containers for displaying live aquatic plants in an aquarium or other water filled environment.

2. Background Art

In addition to the acquisition of fish and other aquatic creatures, aquarium and pond retailers and hobbyists often look to enhance the appearance of their tank and pond displays and the health of the inhabitants by purchasing aquatic plants and placing the plants in the aquarium or pond. To meet these needs, aquarium and pond supply retailers commonly offer aquatic plants in two varieties, artificial plants and live plants. Artificial plants are generally sold in plastic packaging with a transparent window allowing the prospective purchaser to view the plant characteristics. The base of the artificial plant is typically inserted into an enlarged plastic base which may be weighted down by aquarium gravel or other substrate when placed in the water filled environment to keep the base of the plant secured at the bottom of the tank.

Unlike artificial plants, live aquatic plants must be kept in an aquarium underwater prior to sale and thus present other concerns such as maintaining the plants underwater, providing the plants with nutrients and water circulation, displaying the plants in a pleasing manner, and keeping the plants from floating to the surface or becoming tangled up. Retailers or commercial growers commonly weight down clumps of similar loose plants together using a flexible clamping weight and then place the plants in an aquarium for display and resale. The plant clumps are free to move about the tank but generally stay upright as long as the weight remains clamped on. However, live aquatic plants typically slip through the weight clamp and float to the surface of the tank. In addition, the weights often corrode over time and introduce unwanted toxins into the aquarium environment.

Moreover, to maximize storage space, often a large number of plants of differing varieties are stored in the same tank. This can lead to the plants tangling up with one another and presenting an unpleasing appearance as it can be difficult to tell where one plant ends and another begins. Then, every time a plant is removed, there is a likelihood that unselected plants will be removed as well or other plants will be torn free of their weight clamps. In addition, it is difficult to add plants to the tank given the tangled mass that confronts the seller.

Another common device for retaining the plants within an aquarium is a plant basket or pot. These baskets come in standard sizes and typically include a basket section terminating in an uppermost outwardly flared rim. The basket is commonly circular shaped but rectangular, square, oval, and other geometric shapes are also used. The basket may include slots or have a mesh-like outer surface to allow water to flow in and out of the basket. The plants are retained in the basket and the basket is either weighted down or slipped into a correspondingly shaped opening in a frame at the bottom of the tank. The plant basket is usually tapered and is frictionally retained by the circumference of the basket opening in the frame. Such an arrangement is not always satisfactory however as the plastic plant baskets often slip from the plastic or metal frame and float upwards. In addition, the plant basket adds to the overall cost of the aquatic plant and sometimes must be removed prior to installation of the plant in a different location. The plants can also outgrow the plant basket.

Thus, there exists a need for an aquatic plant display system for retailers, commercial growers, and hobbyists with an improved construction for securing live aquatic plants, whether potted or unpotted, in an orderly and pleasing manner within a water filled environment while facilitating the placement and removal of individual plants without inadvertently dislodging neighboring plants.

### SUMMARY OF THE INVENTION

In accordance with a preferred embodiment of the present invention, an aquatic plant display system for use in a water filled environment is provided in a frame with at least one aperture and a gripping element extending into the aperture and including a perforation through which a portion of an aquatic plant may be inserted, the gripping element being constructed to provide multiple points of contact with an aquatic plant to releasably couple the plant to the frame.

In another aspect of the present invention, an anchoring element is provided to provide negative buoyancy to the display system.

In yet another aspect of the present invention, the display system is constructed to accommodate placement and releasable retention of a plurality of unpotted aquatic plants as well as a potted aquatic plants.

Another feature of the present invention is the incorporation of a raised platform or frame deck to enable circulation of water beneath the frame body.

Yet another feature of the present invention is the incorporation of an elastomeric gripping material through which an aquatic plant may be inserted therethrough and releasably retained to the frame.

Other aspects of the present invention will become apparent with further reference to the following drawings and detailed description.

### BRIEF DESCRIPTION OF THE DRAWINGS

FIG. 1 is a front right hand perspective view of an aquatic plant display system in accordance with one embodiment of the present invention;

FIG. 2 is an elevated front view of the aquatic plant display system of FIG. 1;

FIG. 3 is a right hand end view, in enlarged scale, of the display system of FIG. 1;

FIG. 4 is a similar view as in FIG. 2 with a set of pencils representing aquatic plants releasably retained in the display system outside of a normal aquarium setting;

FIG. 5 is a close up sectional view taken from oval 5 in FIG. 4;

FIG. 6 is a top plan view of an exemplary aquatic plant display system in accordance with the present invention placed within an exemplary aquarium;

FIG. 7 is a right hand end view taken along lines 7-7 of FIG. 6 with some exemplary aquatic plants placed in the aquatic plant retainers;

FIG. 8 is a close up view of a plant retainer taken from oval 8 in FIG. 3 and including an exemplary section of an aquatic plant retained therein;

FIG. 9 is a top view of an alternative potted plant retainer;

FIG. 10 is a cutaway side view taken along lines 10-10 of the alternative potted plant retainer in FIG. 9 with an exemplary plant basket placed therein;

FIG. 11 is a cutaway side view on an alternative potted plant retainer with an exemplary plant basket retained therein; and

FIG. 12 is a cutaway side view of a third embodiment of an alternative potted plant retainer.

### DETAILED DESCRIPTION OF THE PREFERRED EMBODIMENTS

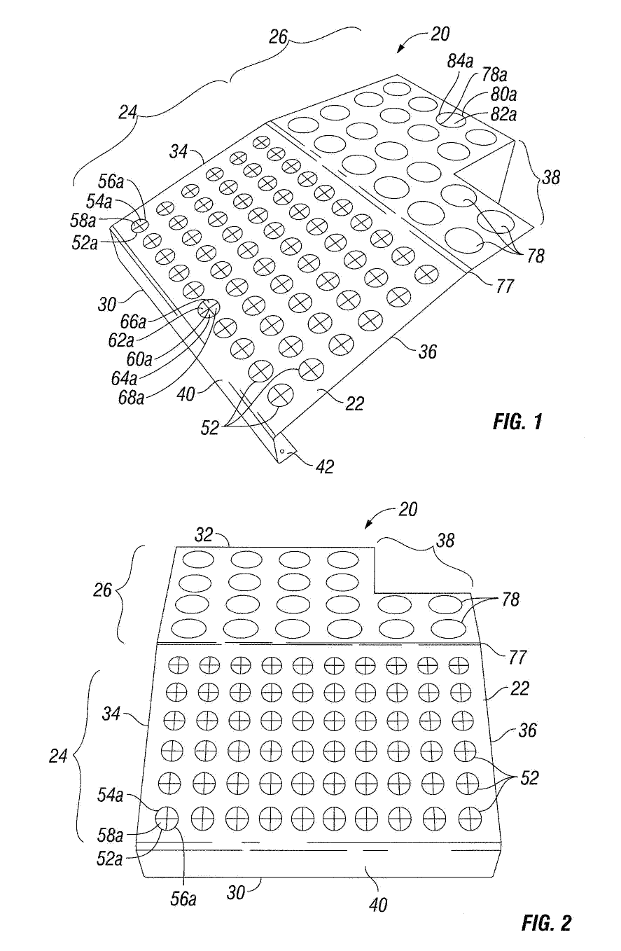

Referring now to FIGS. 1-2, an exemplary aquatic plant display system, generally designated 20, for displaying live aquatic plants in an aquarium or other water filled environment is illustrated. The display system generally includes a rack body 22, frame body, or framework constructed of a single piece of aluminum and separated into a front or lower section 24 and a rear or upper section 26 with both sections cooperating to define a plant display area. As viewed from above as in FIG. 2, the generally rectangular framework 22 includes a front edge 30, a rear edge 32, a left edge 34, and a right edge 36. At the rearmost right hand side in the upper section 26, the rack body 22 includes a rectangular cutout 38 for accommodating placement of the rack body around an in-tank filter (not shown). The framework is preferably of sufficient weight to sink to the bottom of an aquarium or water filled environment. Also, one or more weights may be added to the frame body to ensure negative buoyancy. Thus, the frame body generally forms an anchoring element in the display system 20.

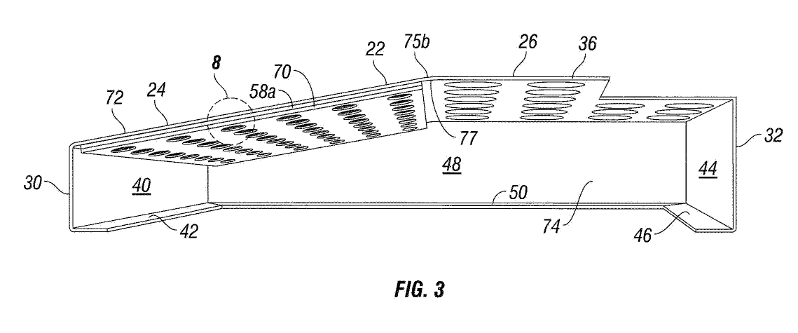

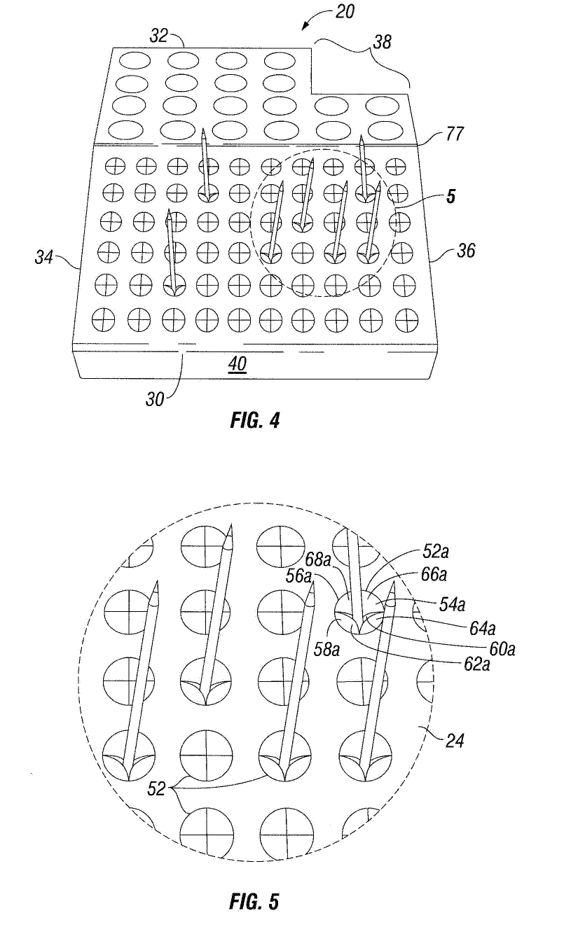

Referring now to FIGS. 1-3, a front wall 40 projects downwardly from the front edge 30 of the rack body 22 and then turns inwardly at a right angle to form a front foot 42 that extends along the width (left edge 34 to right edge 36) of the front section 24. In a similar manner, a rear wall 44 (FIG. 3) projects downwardly from the rear edge 32 of the rack body 22 and then turns toward the front edge of the rack body at a right angle to form a rear foot 46 that extends along the width of the rear section 26 from the left edge 34 to the beginning of the cutout 38. As best viewed in FIG. 3, a left wall 48 descends from the left edge 34 of the rack body 22 and turns inwardly (toward the right edge) at a right angle to form a left foot 50. The left foot rests partially on the inwardly turned front and rear feet 42, 46, respectively, and may be welded, riveted, otherwise fastened thereto at the corners of the rack body. The feet provide additional stability to the rack body 22 and are useful in elevating the upper surface of the display rack body up off of an aquarium floor 114 (FIG. 7) so that water and nutrients may flow about the plant bases. However, it will be appreciated that such feet and corresponding descending walls are an optional feature and one or more of the descending walls (40, 44, or 48) or sections thereof may be used to elevate the rack body off the bottom of the water filled environment.

In this exemplary aquatic plant display system 20, a right foot has been omitted but may be added in a similar fashion to the left foot. However, the omission of the right foot does assist somewhat in the placement and withdrawal of the display rack in relation to the aquarium tank 112 by providing a convenient grasping edge 36 and may also increase the level of water circulation beneath the upper surface of the rack body 22 when placed in the aquarium tank and filled with water. Also, the feet (42, 46, or 50) may include rubber stops (not shown) on their respective bottom surfaces to reduce the relative movement between the display rack and an aquarium floor. It is also feasible to use fasteners securing the rack body to the aquarium instead of weights but this results in the rack body becoming more of a fixture. Thus, in most scenarios, the display system rack will be constructed to sink down into and closely fit within the aquarium confines and movement of the display rack 20 relative to the tank will be inhibited by the walls of the tank. Such construction facilitates removal of the rack when cleaning or other maintenance is necessary.

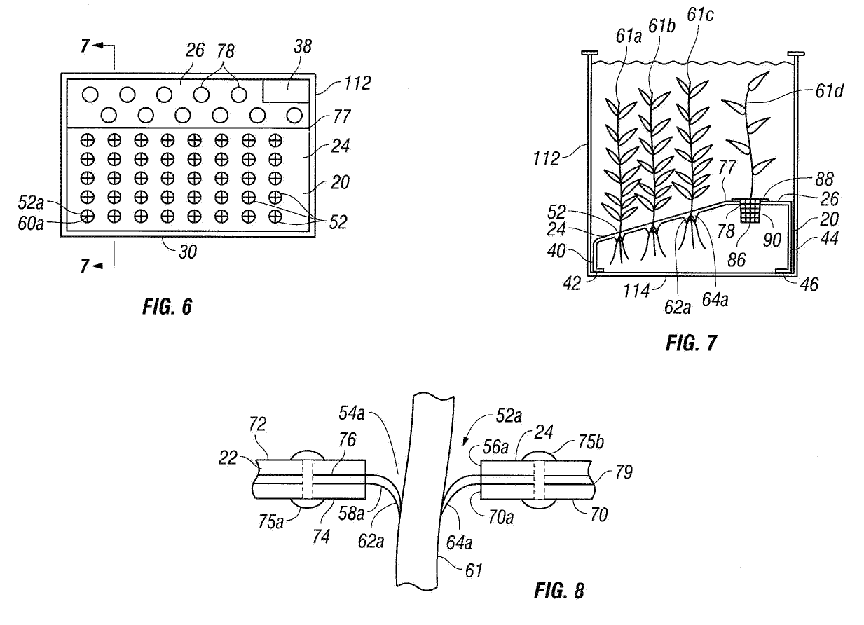

The front or lower section 24 of the aquatic display rack body 22 extends from the front edge 30 of the display rack body at approximately a 10-15 degree upwardly slanting angle measured from a horizontal plane passing through the top edge of the front wall 40 and generally perpendicular thereto and terminates at a smooth (gradually curving) transition ridge 77. In this exemplary embodiment, this lower section includes a plurality of spaced apart, unpotted plant retainers, generally designated 52, for releasably retaining live, unpotted, aquatic plants at various intervals throughout the lower section. In this exemplary embodiment, the front section is subdivided equally into ten columns of spaced apart, unpotted plant retainers with each column including six rows thus providing a ten by six placement matrix for unpotted aquatic plants. In FIG. 6, there are eight columns having five rows each as another illustrative example.

As each of the unpotted plant retainers 52 are constructed identically, an exemplary unpotted plant retainer 52a will now be described with reference to FIGS. 1, 2, 5, and 8. The unpotted plant retainer 52a includes a circular cutout 54a in the aluminum rack body 22 defining an outer rim 56a that defines the maximum width of an unpotted plant that may be retained therein. Spanning across the circular cutout 54a in a plane parallel or substantially parallel to a plane passing through the cutout is a relatively thin sheet of neoprene 58a that includes a perforation in the shape of a cross-hair opening 60a (as shown, for example, five retainers to the right of designation 52a in FIG. 1) to form a perforated aquatic plant gripper through which an aquatic plant base and/or its roots 61 (FIG. 8) may be inserted.

In this exemplary embodiment, the cross-hair opening 60a in the neoprene forms a set of four pie piece shaped flexible retention lips or flaps 62a, 64a, 66a, and 68a. These lips bend and fold and the surrounding neoprene may stretch open when the aquatic plant base 61 (FIG. 8) is pushed through the cross-hair opening or pulled back therethrough. The retention lips may bend both upwardly and downwardly with respect to the surrounding outer rim 56a depending on the direction of the plant base insertion or removal. Generally, the flaps will flex downwardly when the plant base is pushed through the plant gripper and upwardly when the plant base is pulled out of the plant gripper.

Once the plant base 61 is inserted into the neoprene gripper, the retention lips 62a, 64a, 66a, an 68a lay against the plant base to frictionally retain the aquatic plant 61a-c to the rack body 22, essentially forming an adjustable, snug-fitting, elastic collar or gasket around the plant base. The lips or flaps provide points of contact between a portion of the unpotted plant and the plant retainer. These points of contact may occur on opposing sides of the plant base or otherwise cooperate to maintain sufficient pressure on the plant base to releasably retain on or capture the plant to the rack body. The individual rims 56a of the cutouts 54a may act as a frame for supporting a plant gripper for one or more plants. While gently squeezing or gripping the plant base or body sufficiently to prevent the aquatic plant from floating away from the display system 20, the retention lips 62a, 64a, 66a, and 68a will not injure the plant. It will be appreciated that no weight clamp is necessary. The flexible neoprene material also allows the retention lips to adjust to and accommodate a large variety of plant widths up to the size of the surrounding rim 56a as well as accommodating the growth of the plants. The diameter of the unpotted plant retainers is sufficient to receive a typical grouping of aquatic plants as sold in aquarium retail settings but may be dimensioned as desired to retain more or less plant width in an individual retainer 52 as desired such as for larger plants used in outdoor pond settings.

Referring now to FIG. 8, the unpotted plant retainer 52a is provided by sandwiching a thin layer of neoprene 58a between the bottom aluminum surface 76 in the front section 24 of the rack body 22 and the top surface 79 of an aluminum plate 70 that includes similarly sized cutouts 70a to the cutouts 54a of the lower section and aligned therewith to form a passage between the upper surface 72 of the front section and the underneath region 74 of the rack body. The perforations of the neoprene layer are preferably aligned to fall centrally within the corresponding aperture or cutout 54a when viewed from above (FIG. 6) but may be offset as well. The aluminum plate 70 may be welded, riveted (as shown in FIG. 8 by designations 75a, 75b), or otherwise suitably fastened to the inside surface 76 of the front section of the rack body. While this plate 70 could be omitted and the layer of neoprene 58a adhered to the top or bottom surface of the rack body within the front section, sandwiching the neoprene layer between the aluminum plate and the rack body 22 inhibits premature peeling off of the neoprene layer from the rack body over time or due to repeated use and is the preferred approach. Another suitable approach includes sliding a rigid frame shelf with the neoprene layer adhered thereto into a slot between the upper and lower plates or manufacturing the entire rack body from one piece of metal with the neoprene attached thereto. Instead of using a metal, the rack body may also be formed of a plastic material and weighted down to provide negative buoyancy as necessary.

Referring now to FIGS. 1-3, between the lower section 24 and the upper section 26 is the transition ridge 77 that spans in a straight line from the left edge 34 of the rack body 22 to the right edge 36. Starting with the transition ridge, the rear section 26 projects rearwardly to the rear edge 32 of the rack body in a direction parallel to the front and rear feet, 42 and 46, respectively. The rear or upper section 26 of the display rack body 22 includes a plurality of potted plant retainers, generally designated 78. In this exemplary embodiment, there are two front rows having six columns of potted plant retainers and two back rows having four potted plant retainers. The back two rows are shorter than the front two rows due to the filter cutout 38 on the back right side of the rack body. In FIG. 6 for illustrative purposes, there is a front row of six potted plant retainer and a back row of five potted plant retainers with both rows having offset retainers 78 from one another.

As the potted plant retainers are constructed identically, an exemplary potted plant retainer 78a (FIG. 1) will now be described. The potted plant retainer includes a circular cutout 80a defining an opening 82a bounded by an outer rim 84a. As potted aquatic plants come in standard size pots, the opening 82a is of a sufficient size to accommodate such conventional standard pots. A side view of such an exemplary plant pot 86 is illustrated in FIGS. 7, 10, and 11. A conventional plant pot or plant basket 86 typically includes an upper rim 88 and a tapered lower body section 90 forming the basket that may or may not include mesh-like openings for the plant roots. The potted plant retainer 78a provides a rim, collar, or frame 84a for the plant pot with the surrounding area preventing the plant pot from slipping all the way through the rack body due to interference with the basket rim 88 and also providing a snug fit between the outer rim 84a and the lower body section 90 decreasing the tendency of the plant pot to float away from the rack body 22.

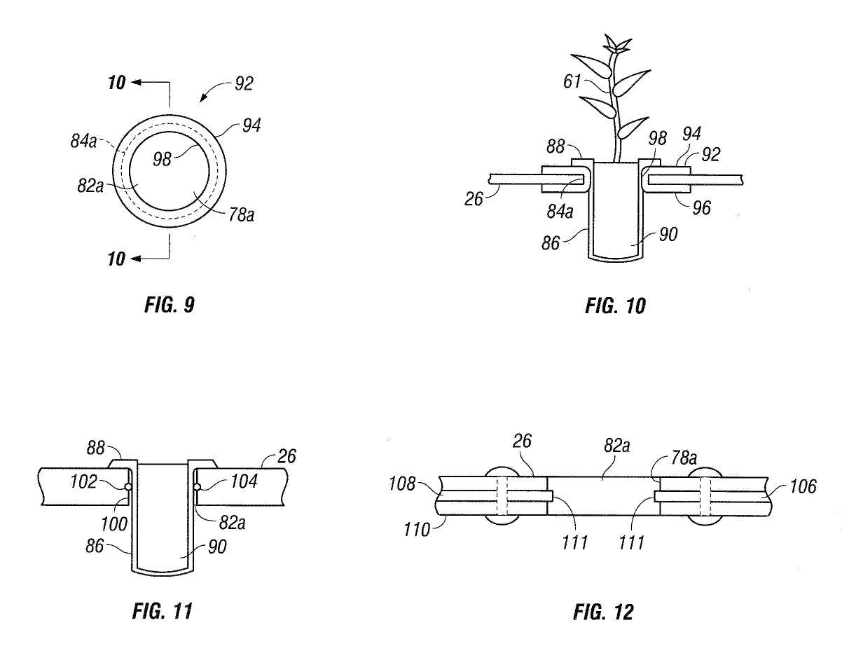

However, in some instances, the relatively low frictional interaction between the plastic plant pot and metal or plastic frame body 22 may allow the plant basket to work itself free and float away. To further prevent such instances, a gasket 92 may be used. Referring initially to FIGS. 9-10, a first exemplary gasket 92 formed of neoprene to enhance the retentiveness of a potted plant retainer 78a around a plant basket 86 is illustrated. The gasket 92 forms a ring or plant pot gripper with an upper disk 94 and a spaced apart lower disk 96 that may slipped over the outer rim 84a of the potted plant retainer disposing a retention collar 98 partially within the confines of the potted plant opening 82a. The retention collar is slightly compressible. The outer surface of the plant pot body 90 is frictionally retained to the rack body 22 by the retention collar 98 as shown in FIG. 10. In this exemplary embodiment, the rack body requires no modification as the gasket may be slipped onto an existing potted plant retainer 78.

Turning now to FIG. 11, a second exemplary embodiment of a plant pot retainer is illustrated. In this embodiment, the sidewall 100 of the potted plant retainer includes a notch 102 for receipt of a ring gasket 104 or plant pot gripper inserted therein. The ring gasket is preferably constructed of neoprene and is rolled into the notch and retained therein. The ring gasket protrudes slightly into the opening 82a of the potted plant retainer 78a and as with the previous embodiment increases the retentiveness of the potted plant to the rack body.

A third embodiment of the potted plant gasket is illustrated in FIG. 12. This gasket 106 is a layer of neoprene 108 sandwiched between the inner surface 76 of the rack body in the upper section 26 and the interior surface of a clamping plate 110 similar to the construction in the lower section. In this instance, however, the opening in the neoprene layer is almost coextensive with the potted plant opening 82a in the potted plant retainer 78a of the rack body 22 and only protrudes into the opening 82a a few millimeters to provide a retention ring 111. As with the gaskets discussed above, the inner edges of the neoprene retention ring that protrude into the potted plant opening 82a are slightly compressible and enhance the retentiveness of the rack body to the potted plant base.

In use, with reference to FIGS. 1, 6, and 7, the aquatic plant display system 20 is placed within an aquarium 112 (or other water filled environment) with the front and rear feet 42 and 46, respectively, resting on the floor 114 of the tank and orienting the front section 24 near the front wall of the aquarium. The weight of the aquatic plant display system 20 assists in keeping the rack body 22 in place on the floor of the tank. If a filter (not shown) is installed in the tank, the cutout 38 is aligned with the filter to partially surround the filter. The user may then fill the tank to the desired capacity with water allowing for the placement of the plants 61a, 61b, 61c, and 61d therein. If the aquatic plant 61a, 61b, or 61c is unpotted, the plant roots may be inserted through an available opening 52 in the neoprene holder in the front section 24. If the plant is potted, as designated by reference numeral 61d in FIG. 7, the plant basket 86 may be inserted into an available potted plant retainer 78. Once all the plants have been placed in the aquarium, the user may fill the tank with water to capacity as desired. The tank may also be filled taking into account the subsequent addition of the plants and the plants placed in the plant grippers afterwards.

After locating the desired plant or group of plants, to remove an unpotted plant 61a, 61b, or 61c, it is a simple matter to grasp the aquatic unpotted plant near the base section just above the display rack body 22 upper surface surrounding the plant and slide the plant from the corresponding neoprene retainer 52. No harm to the plant will occur from withdrawing it in this manner. The plant may be placed in a bag with water or other suitable container for transportation. In a similar manner, a potted plant 61d may be withdrawn by the user by grasping the upper rim 88 of the plant pot 86 and pulling upwards from the display rack body 22 and away from the potted plant retainer 78. A slight twisting motion may further facilitate the removal of the potted plant. A printed layout matching the layout of the rack body and labeled accordingly with the plant varieties maintained in the tank may be adhered to the side of the tank showing the location of each plant as well if multiple varieties are used thus further facilitating location and removal of the desired plants.

It will be appreciated that the aquatic plants 61a-d are kept in a pleasing order and may easily be inserted into open retainers 52 or 78, held in place until the desired time, and then removed in simple fashion. Jostling of nearby plants will not prematurely release them from their respective retainers. The spacing of the retainers keeps the plants somewhat spaced apart and organized as well and reduces entanglements. The retainers assist in keeping the live aquatic plants from floating away and instead maintain the plants in an upright position. The spacing of the retainers allows a potential purchaser to view the plants without clutter and prevents too many plants from being crammed into one area. The upwardly angled front section also adds to the displayability of the plants in the tank by allowing for various height placements. A terrace or stepped front section could be used as an alternative to the gradually upwardly sloping front section 24.

Referring now to FIGS. 1-3 and 8, an exemplary method of manufacturing the display system 20 may be performed by cutting or stamping a single, flat sheet of aluminum into the desired shape and then stamping out the desired hole pattern. The display rack may then be flipped over on its back and a layer of neoprene 58a stretched over inside surface 76 of the front section 24 to cover the hole pattern. A second flat sheet of aluminum 70 is placed over the neoprene and riveted to the main body 22. The entire assembled body may then be bent into the desired shape to form the front wall 40 and front foot 42, rear wall 44 and rear foot 46, and side wall 48 and side foot 50. The front and rear feet may be riveted to the side foot for extra rigidity. A cutting tool is then used to perforate cross hair patterns into the neoprene sheets to form the neoprene plant retainers. The display rack may also be powder coated to a desired color. If the optional gaskets are used in the upper section 26, these are installed prior to shipping the display rack to the downstream retailer.

It will be appreciated that the aquatic plant display system 20 may consist entirely of the unpotted plant retainers 52 and omit the potted plant retainer section 26 altogether. Each section 24 or 26 may also include a mixture of unpotted plant retainers and potted plant retainers. In addition, the upper surface of the display rack may be entirely flat or shaped to conform to other environments. While the embodiments discussed herein incorporate an aluminum rack body, other corrosion resistant materials suitable for long periods of storage in a water filled environment without harming the surrounding plant life may also be used. The display rack may also be customized to fit snugly within the aquarium and one or more display racks may be used together to form a display rack flooring system covering the aquarium floor. It will further be appreciated that the neoprene has sufficient gripping capacity to prevent an aquatic plant from floating away from the display rack without injuring the plant. In addition, the neoprene does not chemically injure the plant either. Other suitable materials including other synthetic rubber materials, elastomeric materials, and soft plastic materials will occur to one of ordinary skill in the art. More rigid plastic materials may be used for more durable plants but the softer elastomeric materials are preferred. Also, if a filter or other in-tank device is used, the display rack may include a cutout or similar void to accommodate placement around such device in the aquarium or water filled environment.

While the previous embodiments have been described in terms of releasably retaining live aquatic unpotted and potted plants, the unpotted plant retainers 52 of the display rack may also retain artificial aquatic plants in place of the enlarged plastic base that normally accompanies such fake plants. Also, while the rack body has been described in terms of a discrete unpotted plant retainer section and a potted plant retainer section, this is merely for illustrative purposes and the unpotted plant retainers and potted plant retainer may appear mixed together in the same section. As shown in FIG. 1, the retainers 52 and 78 are spaced evenly throughout their sections but in FIG. 6, the upper section 26 retainers 78 are staggered in relation to adjacent rows. Other spacings will occur to one of ordinary skill in the art. Also, other geometric or stylized shapes may be used to accommodate like shaped plant baskets and the circular openings are meant for illustrative purposes and not meant to be limiting in any manner.

It will be appreciated that the display system 20 maintains the plants in the water, in a generally upright position as the top ends of the plants typically float. The rack also provides some organizational structure to displaying the plants. When removing the plants from the rack, a selected plant may easily be withdrawn from the rack by grasping near the base where the plant enters the rack. This reduces the likelihood of inadvertently removing other non-selected plants. The neoprene stretches to accommodate plant growth and the roots are maintained beneath the plate in a circulation pathway. The gentle squeezing provided by the lips, flaps, or gripping elements on the plant body is sufficient to maintain the plants in place without harming them. In addition, fewer plants will loosen themselves from the rack body and float away. Thus, there is much less handling required which occurs when the plants must constantly be put back in place as in the prior art.

It will also be appreciated that the relatively snug-fitting neoprene grippers also reduce the amount of gravel and sand if used on top of the rack body getting beneath the elevated rack surface and keep the area underneath relatively free from debris while allowing the nutrients in the water to reach the plant roots. The neoprene also allows for growth and the raised rack body allows for root growth beneath the holders. Circulation is also improved by raising the plants of the bottom of the tank.

While the present invention has been described herein in terms of a number of preferred embodiments, it will be appreciated that various changes, uses, and improvements may also be made to the invention without departing from the scope and spirit thereof. As a non-limiting example, the frames and gripping elements may be used individually or set within a frame body as a single piece apparatus or a multi-piece apparatus. Also, it will be appreciated that the gripping element may be attached remotely to the rack body or anchoring element. As one example, the anchoring element may reside beneath the gripping element on the floor of the tank. The gripping may float or otherwise be rigidly connected for disposition above the anchoring element. As another example, the anchoring element may incorporate an aperture as described above but the gripping element may be submerged beneath the aperture thereby extended below the anchoring element deck or plate. Yet a third example may be the incorporation of a frame or hoop connected to the anchoring element with the gripping element disposed within and held in place by the frame. Such a frame could extend in any direction from the anchoring element. All such embodiments would fall within the scope of the present invention.

In addition to the foregoing, while the neoprene gripping elements are generally disposed in a plane parallel to the corresponding circular cutouts, the gripping elements may be angled with respect to the cutouts without detracting from the spirit and scope of the invention.

Other applications for the display system include the provision of one or more floating devices with no anchor or slightly buoyant such as for floating plants in ponds. For instance, a single or multiple unit floating frame manufactured of a floating material such as plastic or a foam based material may incorporate a frame defining an aperture spanned by a perforated neoprene or elastomeric skin for holding the plants roots in the water but maintain the remaining plant components above water. Such floating frame may be tethered to the bottom or side of the water filled environment or simply float freely about. Such examples demonstrate the flexibility of the aquatic plant display system described herein to accommodate a number of plant display scenarios.

What is claimed is:

1. An aquatic plant display system for use in a water filled environment comprising:
a frame with at least one aperture;
a gripping element extending into the aperture and including a perforation through which a portion of an aquatic plant may be inserted, the gripping element constructed to provide multiple points of contact with an aquatic plant to releasably couple the plant to the frame.

2. The aquatic plant display system as set forth in claim 1 further comprising:
an anchoring element coupled to the frame for sinking the frame to a bottom surface of the water filled environment.

3. The aquatic plant display system as set forth in claim 1 wherein:
the frame includes at least one foot to raise the frame off a bottom surface of the water filled environment.

4. The aquatic plant display system as set forth in claim 1 wherein:
the gripping element includes a plurality of resilient, pliable flaps constructed to expand when inserting a portion of the plant through the gripping element and constrict about the portion of the plant residing within the aperture.

5. The aquatic plant display system as set forth in claim 1 wherein:
the gripping element perforation is in the shape of a cross-hair forming four retention flaps.

6. The aquatic plant display system as set forth in claim 1 wherein:
the frame includes a front section angled in relation to a rear section for displaying aquatic plants.

7. The aquatic plant display system as set forth in claim 1 wherein:
the frame includes a first set of gripping elements for releasably retaining a plurality of unpotted aquatic plants and a second set of gripping elements for releasably retaining a plurality of potted aquatic plants.

8. The aquatic plant display system as set forth in claim 1 wherein:
the gripping element is a layer of elastomeric material.

9. The aquatic plant display system as set forth in claim 1 wherein:
the gripping element is an elastomeric gasket around at least a portion of the perimeter of the aperture.

10. The aquatic plant display system as set forth in claim 1 wherein:
the frame includes a plurality of spaced apart gripping elements.

11. The aquatic plant display system as set forth in claim 1 wherein:
the gripping element is constructed to flex downwardly as the aquatic plant is depressed therethrough and maintain a downwardly flexed configuration while releasably coupling the plant to the frame.

12. The aquatic plant display system as set forth in claim 12 wherein:
the gripping element is further constructed to flex upwardly as the aquatic plant is removed from the frame.

13. The aquatic plant display system as set forth in claim 1 wherein:
the frame includes an upper and lower plate sandwiching an elastomeric layer projecting into the aperture.

14. The aquatic plant display system as set forth in claim 1 wherein:
a horizontal plane projects through the aperture and the gripping element resides in a plane parallel to the horizontal plane.

15. The aquatic plant display system as set forth in claim 1 wherein:
the frame includes a plurality of mixed sized apertures with at least some of the gripping elements spanning a majority of the aperture widths for unpotted aquatic plants and at least some of the gripping elements spanning less than a majority of the aperture widths for potted aquatic plants.

16. An aquatic plant display system for use in a water filled environment having a bottom surface comprising:
a framework defining a plurality of apertures and weighted to sink toward the bottom surface of the water filled environment;
at least one leg coupled to the framework for raising the framework off the bottom surface of the tank; and
an aquatic plant gripping element coupled to the framework, the gripping element including a plurality of perforated regions aligned with the plurality of apertures to dispose at least one perforated region in each aperture, each perforated region further including a pliable, resilient, elastomeric material constructed to releasably retain one or more aquatic plants to the framework.

17. The aquatic plant display system as set forth in claim 16 wherein:
at least one perforated region includes a cross-hair shaped opening defining a set of flaps constructed to contact a portion of the one or more aquatic plants releasably retained thereby.

18. The aquatic plant display system as set forth in claim 16 wherein:
the elastomeric material is constructed to flex downwardly as a portion of the one or more aquatic plants is inserted into the aperture and flex upwardly as the one or more aquatic plants are withdrawn from the aperture.

19. A method of displaying aquatic plants in a water filled environment comprising:
providing a weighted framework with a top surface and a bottom surface and a plurality of apertures passing therethrough;
providing a gripping element coupled to the framework and covering the plurality of apertures, the gripping element including at least one perforated region aligned with at least one aperture and including an elastomeric material constructed to contact a portion of one or more aquatic plants and releasably retain the plants to the framework;
disposing the weighted framework in the water filled environment;
selecting an aperture with a gripping element having a perforated region;
inserting one or more aquatic plants into the perforated region; and
releasably retaining the one or more aquatic plants to the gripping element.

20. The method of displaying aquatic plants as set forth in claim 19 further comprising:
repeating the inserting and releasably retaining steps for a plurality of aquatic plants to arrange the plants for display on the framework.
